(19) United States
(12) Patent Application Publication
(10) Pub. No.: US 2023/0247029 A1
(43) Pub. Date: Aug. 3, 2023

(54) VERBAL WORKFLOW MANAGEMENT SYSTEM

(71) Applicant: William Crose, Rochester Hills, MI (US)

(72) Inventor: William Crose, Rochester Hills, MI (US)

(21) Appl. No.: 18/162,002

(22) Filed: Jan. 31, 2023

Related U.S. Application Data
(60) Provisional application No. 63/304,985, filed on Jan. 31, 2022.

(51) Int. Cl. H04L 9/40; G06F 21/62; G06Q 10/0633; G06Q 10/0639

(52) U.S. Cl. CPC H04L 63/105; G06F 21/629; G06Q 10/0633; G06Q 10/0639

(57) ABSTRACT

A method for configuring and executing one or more workflows including: a) a first user with administrative privileges logging into an application of a verbal workflow management system, b) the first user configuring the one or more workflows, c) the second user associated with the user privileges logging into the application via a second computing device which includes and/or is affixed to an audio device, d) the second user verbally requesting one or more workflows, e) the audio device audibly executing via the speaker one or more steps associated with the one or more workflows such that the second user hears the one or more steps as one or more verbal instructions and is able to commence performing one or more actions associated with the one or more steps to complete the one or more workflows.

### CROSS-REFERENCE TO RELATED APPLICATIONS

The present application claims benefit of and priority to U.S. Provisional Application No. 63/304,985 filed on Jan. 31, 2022, which is incorporated herein by reference in its entirety.

### FIELD

The present teachings are generally related to a system and methods for operating a verbal workflow management system. The teachings herein may be useful in providing audible standard operating procedures to workers. The teachings herein may provide a system and method which may provide secure, valid, unbiased, reliable work performance data to users and managers.

### BACKGROUND

People who work with their hands include every service worker worldwide from bartender to hair stylist, every medical/healthcare professional, engineers of all types, assemblers, installers, inspectors, maintenance workers, scientists, and others. Each is typically required to memorize the standard operating procedures required of their jobs before starting work, which often means being trained well enough to recall each process step in the proper order, every time, while on the job. While working, these workers generally cannot stop working to safely, efficiently, or sanitarily access various performance aids such as printed instructions, videos, or online support. This can lead to poor and inconsistent service and product quality at best, or personal or client injury or death and property damage at worst. When it becomes necessary to change a standard operating procedure, rapid implementation can be critical to safety, quality, and the business' competitive advantage.

Existing change management options are no friend to learning as time consuming and costly documentation must be created, new training designed, developed, and delivered, and workers must forget the old processes, re-memorize the new, then perfectly recall the updated procedure while on the job. Current change management practices are often sufficient for responding to infrequent change but are unsustainable when the rate of change exceeds a worker's capacity to memorize, forget, then re-memorize standard operating procedures and a business' ability to fund large or frequent change initiatives. While some workflows are able to be memorized, some workflows may be difficult or near impossible to memorize due to having too many steps, the process occurring too infrequently to be allow for repetition and memorization, or even the process having too many options or deviations to allow for memorization and consistent quality.

Change driven by new equipment, product, services, policies, process optimization, and other non-worker factors can be expected to increase as innovation accelerates. As innovation accelerates, the number of workers needed in the pre-automation phases of product and service development will increase. The nature of their work will require these workers to perform assigned workflows with little to no training, as part of their job will be to develop and optimize new standard operating procedures and create the data needed to automate processes. Once automated, workers will move to develop another product or service.

What is needed is a workflow management system which can be used by businesses to enable workers to perform new and changing standard operating procedures at a low cost and in the shortest amount of time. What is needed is a workflow management system which can enable workers to perform workflows without first memorizing their assigned workflows (e.g., standard operating procedure(s)). What is needed is a workflow management system which can be delivered audibly such that workers may avoid first memorizing their assigned workflows. What is needed is a workflow management system which can aid in ensuring workers perform every step of every standard operating procedure, in the proper sequence, every time, anywhere in the world. What is needed is a workflow management system which can capture valid, unbiased, and reliable performance data to the individual, management, and others. What is needed is a system which can collect performance data without requiring observation by others.

### SUMMARY

The teachings herein relate generally to manual workers in any industry worldwide who cannot safely, efficiently, or sanitarily access computers, handheld devices, or other performance aids as they work. The subject matter also relates to any worker assigned to perform standard operating procedures that are performed too infrequently to memorize, that have too many steps to memorize, have steps that change too often to memorize, or have critical steps that must never be left to memory. The subject matter also relates to people with disabilities including visual, memory, and attention deficits who would otherwise have great difficulty or would not be able to perform certain work.

The present teachings relate to a method for configuring and executing one or more workflows including: a) a processor receiving and automatically confirming administrative credentials and allowing a first user to access an application of a verbal workflow management system executed on a first computing device, wherein the administrative credentials are entered by the first user having administrative privileges into the application via a first user interface of the first computing device, and wherein the processor is remotely located from the first computing device; b) the processor receiving and automatically storing a plurality of workflow data including one or more workflows and one or more organizations, one or more curricula, one or more users, one or more devices, one or more roles, or a combination thereof, wherein the workflow data is configured by the first user via the first user interface, wherein the one or more users include a second user, and wherein the one or more roles include user privileges; c) the processor receiving and automatically confirming user credentials and allowing the second user to access the application of the verbal workflow management system executed on a second computing device, wherein the user credentials are entered by the second user having the user privileges into the application via a second user interface of the second computing device, and wherein the second computing devices includes, is affixed to, and/or is in communication with an audio device having at least one speaker and one microphone, and wherein the processor is remotely located from the second computing device; d) the processor receiving a verbal request for one or more workflows, wherein the one or more workflows are verbally requested by the second user into the microphone of the audio device as the verbal request, and wherein the verbal request is transmitted from the second computing device; e) the processor automatically identifying the one or more workflows which match the verbal request and transferring to the application of the second computing device; and wherein upon receipt of the one or more workflows, the audio device audibly executes via the speaker one or more steps associated with the one or more workflows such that the second user hears the one or more steps as one or more verbal instructions and is able to commence performing one or more actions associated with the one or more steps to complete the one or more workflows.

A method for configuring and executing one or more workflows including: a) a first user with administrative privileges logging into an application of a verbal workflow management system via a first user interface of a first computing device with administrative credentials; b) the first computing device transmitting the administrative credentials to a remotely located processor and the processor automatically confirming the administrative credentials and allowing the first user to access into the application; c) the first user configuring the one or more workflows and configuring one or more organizations, curricula, users, devices, roles, or a combination thereof via the first user interface, wherein the one or more users include a second user and the one or more roles include user privileges; d) the second user associated with the user privileges logging into another application of the verbal workflow management system via a second user interface of a second computing device with user credentials, wherein the second computing devices includes and/or is affixed to an audio device having at least one speaker and one microphone; e) the second computing device transmitting the user credentials to the remotely located processor and the processor automatically confirming the user credentials and allowing the second user to access into the other application; f) the one or more second users verbally requesting one or more workflows into the microphone of the audio device as a verbal request; g) the application in the second computing device transferring the verbal request to the remotely located processor to access the one or more workflows; h) the remotely located processor identifying the one or more workflows which match the verbal request and transferring to the application of the second computing device; i) the audio device audibly executing via the speaker one or more steps associated with the one or more workflows such that the second user hears the one or more steps as one or more verbal instructions and is able to commence performing one or more actions associated with the one or more steps to complete the one or more workflows.

The present teachings disclose a novel verbal workflow management system. The system allows for a user to verbally request, then audibly receive, a standard operating procedure (also referred to as workflow) to allow performance, one step-at-a-time. The workflow may be in English or the user's preferred language. The system may provide for automatic translation. The system may also be advantageous in automatically capturing and recording the time users spend on each step (e.g., “duration”), even capturing user-provided feedback for continuous improvement purposes, then saving all captured feedback, performance interval (“duration”), event, and performer data. The data may be saved to one performance database record, one feedback record, or both per performance event.

The system may use database records with one text field per standard operating procedure step. The present teachings may be advantageous by storing most, if not all, of the data in a cloud-based database remote from the site location of a user's device. Allowing for remote storage may allow for the data to be secure, such as from accidental onsite editing, onsite physical damage, cyber-attacks, unauthorized user(s), and the like. The system may provide for encryption for data being transferred from and received by a user's audio device, computing device, and even from the memory storage device (e.g., server).

The system of the present teachings may be advantageous by having a conversational interface and even having an automatic translation service which may be used to convert user speech to text and text to speech in the user's preferred language. Users may navigate the system using their speech, mechanical button presses, motions or a combination thereof on a mobile device having or being in communication with an audio device; a motion-sensing wearable such as a glove, hat, shoe or other wearable, a pen; or other device capable of receiving and to digital storage systems and devices. Navigation by speech may be particularly advantageous in allowing a user to focus use of their hands to complete a workflow and avoid wasted time of manually navigating through a user interface.

The system enables the valid, unbiased, reliable performance interval data it automatically collects to be reported in various ways including comparison to a mean or median or mode performance interval, financial return on investment, break even projection, and unlimited others that leverage individual performance intervals or aggregates, mean or median or mode performance interval calculations, valid, unbiased, reliable performance interval data at individual worker and process step detail, color-coded displays in relation to each event's standard deviation from the mean or median or mode, or other report.

### BRIEF DESCRIPTION OF DRAWINGS

FIG. 1 illustrates a verbal workflow management system.

FIG. 2 illustrates a record associated with a set of work instructions (also referred to as a workflow).

FIG. 3 illustrates a record database.

FIG. 4 illustrates verbal commands for executing a record 100 as a verbal workflow.

FIG. 5 illustrates a performance report.

FIG. 6 illustrates a performance report querier.

FIG. 7 illustrates a performance curve.

FIG. 8 illustrates a feedback report.

FIG. 9 illustrates an administrative process.

FIG. 10 illustrates a workflow configuration process.

FIG. 11 illustrates operation of a login routine.

FIG. 12 illustrates operation of a request routine.

FIG. 13 illustrates an index of how FIGS. 13A-D relate.

FIG. 13A illustrates a portion of a step routine.

FIG. 13B illustrates a portion of a step routine continued from FIG. 13A.

FIG. 13C illustrates a portion of a step routine continued from FIG. 13B.

FIG. 13D illustrates a portion of a step routine continued from FIG. 13C.

FIG. 14 illustrates a report process.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Embodiments of the present disclosure may be described herein in terms of functional and/or logical components and various processing steps. It should be appreciated that such components may be realized by any number of hardware, software, and/or firmware components configured to perform the specified functions. For example, an embodiment of the present disclosure may employ various integrated software applications, memory elements, digital signal processing elements, logic elements, databases, or the like, which may carry out a variety of functions under the control of one or more microprocessors or other control devices. In addition, those skilled in the art will appreciate that embodiments of the present disclosure may be practiced in conjunction with any number of systems, and that the systems described herein are merely exemplary embodiments of the present disclosure.

For the sake of brevity, conventional techniques related to signal processing, data transmission, signaling, control, and other functional aspects of the systems and the individual operating components of the systems, may not be described in detail herein. Furthermore, the connecting lines shown in the various figures contained herein are intended to represent example functional relationships and/or physical connections between various elements. It should be noted that many alternative or additional functional relationships or physical connections may be present in an embodiment of the present disclosure.

Verbal Workflow Management System

The present teachings relate to an apparatus, systems, techniques and articles, and data for a verbal workflow management system. The verbal workflow management system can enable and even assure organizations including global businesses to create, optimize, scale, verbally deliver in one or many languages, and continuously improve performance across the organization including worker and non-worker performance discrepancies. The verbal workflow management system can enable organizations to save time and money by writing workflow instructions in one language, then translate the instructions to many other languages on-the-fly. The verbal workflow management system can enable organizations to securely deliver workflows to workers worldwide using various techniques including, but not limited to, geolocation services and comparison, encryption/decryption, on-the-fly operation/not saving any data outside the server, and user logins and permissions. The verbal workflow management system can enable organizations including global businesses to create, optimize, scale, verbally deliver in one or many languages, and continuously improve performance across the organization including worker and non-worker performance discrepancies.

The system makes workflow management and continuous improvement more efficient by enabling workflows to be developed, optimized, and continuously improved within a single system. Industrial engineers and others create workflows/standard operating systems within the system to define the workflow, the workflows are shared with progressively larger groups of globally-located workers, capture the time testers/workers spend on each workflow step to measure performance, use system reports to analyze the performance data, edit workflows as advised by the data to improve the workflows, and control workflow performance by verbally-delivering each step as testers/workers perform them, all from the same system.

The verbal workflow management system can improve the safety, efficiency, and sanitation of people who cannot safely, efficiently, or aseptically stop working to access computers, mobile devices, printed aids, or other aids to receive traditional performance support as they work by assuring they perform every step of every workflow in the proper sequence every time they perform the workflow, anywhere in the world. The verbal workflow management system can improve the safety, efficiency, and sanitation of people who can access computers, mobile devices, printed aids, or other aids to receive traditional performance support as they work by assuring they perform every step of every workflow in the proper sequence every time they perform the workflow, anywhere in the world.

The verbal workflow management system can reduce the time and cost of training workers to perfectly perform assigned workflows by enabling workers to follow verbally delivered workflow steps as they work and enable memorization of the workflow through repetition. The verbal workflow management system can enable workers, including those with certain disabilities including vision, memory, and attention deficit, to perform workflows they could otherwise not perform, by receiving verbally delivered instructions, step-by-step, as they work, anywhere in the world.

The verbal workflow management system can improve and accelerate an organization's response to change by enabling workflows to be updated and delivered globally in seconds. The verbal workflow management system can improve worker performance by assuring every step of every workflow is delivered with zero variation worldwide, every time the workflow is performed, except for the moments when a new or edited workflow replaces an obsolete workflow. The verbal workflow management system can improve and accelerate an organization's response to change by enabling workflows to be updated and delivered globally in seconds.

The verbal workflow management system can improve worker safety, reduce property damage, and reduce waste by enabling workers to verbally request help from a supervisor as they work.

The verbal workflow management system captures the time workers spend on each workflow step. The resulting data is always valid, unbiased, and reliable with significant usage. The data is used to reveal continuous improvement opportunities and advise interventions in many ways including, but not limited to compensation administration, equipment procurement and repair, policy development and adjustment, staffing, best practices and process change, break-even projections and financial return on continuous improvement investments.

The present teachings relate to a verbal workflow management system. The verbal workflow management system may function to record work instructions, convert verbal work instructions to readable work instructions (e.g., voice-to-text), translate work instructions, store work instructions, play work instructions, provide secure access to create/edit/play work instructions, allow for reports to be generated on performance of the work instructions, or a combination thereof. The verbal workflow management system may provide for a means for an audio device, computing device, or both to access, create, and/or edit work instructions stored remotely therefrom; receive feedback regarding work instructions and/or performance from a user in real-time; upload recorded work instructions to one or more memory storage devices; download recorded work instructions from one or more memory storage devices; edit recorded work instructions by verbal and/or text-based editing; develop one or more work instruction reports; or any combination thereof. The verbal workflow management system may include one or more audio devices, computing devices, applications, networks, servers, processors, memory storage devices, the like, or any combination thereof.

The verbal workflow management system may include one or more audio devices. The audio device may function to relay audible work instructions to a user, receive audible work instructions from a user, transmit one or more audible signals to and/or from a computing device, convert one or more signals into one or more audible sounds, convert one or more audible sounds into one or more signals, the like, or any combination thereof. The audio device may be any type of device suitable for being located in proximity to a user while a user completes the work instructions, creates or edits work instructions, or any combination thereof. The audio device may include one or more speakers, microphones, processors, memory storage devices, transceivers, power sources, connections, communication modules, the like, or any combination thereof. The audio device may be wired or wireless. The audio device may include one or more headsets, headphones, free standing speakers with a microphone input, the like, or any combination thereof. Exemplary audio devices may include those disclosed in U.S. Pat. No. 9,595,201; US Publication No. 2019/0267002; both of which are incorporated herein by reference in their entirety. Further exemplary audio devices may include AirPods® by Apple® (e.g., AirPods Pro, AirPods 3^{rd}Generation), which are incorporated herein by reference. The audio device may be integrated into a computing device or may cooperate with a computing device. The audio device may be in wireless or wired communication with one or more computing devices, a network, or both.

The verbal workflow management system may include one or more computing devices. The one or more computing devices may function to receive and/or transmit one or more signals, convert one or more signals to one or more data entries, cooperate with an application, be accessible by a user, be remotely located from a user, have one or more databases stored thereon, have one or more processes (e.g., software) stored thereon, the like, or any combination thereof. A computing device may include an application stored thereon or accessible therefrom. One or more computing devices may communicate via one or more interaction interfaces (e.g., an application programming interface (“API”)). One or more computing devices may include one or more processors, storage mediums, servers, speakers, microphones, user interfaces, keyboards, communication modules, the like, or any combination thereof. One or more computing devices may include one or more mobile devices, desktop computers, the like, or any combination thereof. One or more mobile devices may include one or more mobile phones (e.g., smart phone), tablets, laptop computers, the like, or any combination thereof. One or more computing devices may be in communication with one or more other computing devices via a network. For example, a computing device associated with a user (e.g., mobile device) may be in communication with a server via a network.

The verbal workflow management system may include one or more applications. The application (i.e., “computer program”) may function to execute at least part of one or more processes of the present disclosure; connect an audio device, mobile device, or both to one or more other application interfaces, computing devices, databases, the like; or any combination thereof. The application may be stored on one or more memory storage devices. The application may be stored on a memory storage device of a mobile device or audio device. The application may comprise one or more computer-executable instructions, algorithms, rules, processes, methods, user interfaces, menus, databases, the like, or any combination thereof. The computer-executable instructions, when executed by a computing device may cause the computing device to perform one or more methods described herein. The application may be downloaded, accessible without downloading, or both. The application may be downloadable onto one or more mobile devices. The application may be downloadable from an application store (i.e., “app store”). An application store may include, but is not limited to, Apple App Store, Google Play, Amazon Appstore, the like, or any combination thereof. The application may be accessible without downloading onto one or more mobile devices. The application may be accessible via one or more web browsers. The application may be accessible as a website. The application may interact and/or communicate through one or more interaction interfaces. The application may be utilized by one or more mobile devices. The application may be utilized on one or more mobile devices. The application may also be referred to as a dedicated application. The application may provide for the secure exchange of standard operating procedures. The application may provide for data encryption and decryption. The application may provide for automatic data encryption when transmitting data to an audio device, another computing device (e.g., server), or both. The application may provide for automatic data decryption when receiving data from an audio device, another computing device (e.g., server), or both.

The verbal workflow management system may include one or more user interfaces. The one or more user interfaces may function to receive input from one or more users, relay output to one or more users, or both. The one or more user interfaces may be part of one or more computing devices, audio devices, or both. The one or more user interfaces may include one or more microphones, speakers, control mechanisms, the like, or any combination thereof. The one or more user interfaces may include one or more visual interfaces, one or more input devices, or both. Exemplary user interfaces may be disclosed in US Patent Publication No. 2019/0267002, incorporated herein by reference in its entirety.

The verbal workflow management system may include one or more communication modules. The one or more communication modules may allow for the computing device, audio device, or both to receive and/or transmit one or more signals from one or more other computing devices, be integrated into a network, communicate with an application interface, or any combination thereof. The one or more communication modules may have any configuration which may allow for one or more data signals from one computing device to be relayed to one or more communication modules, communication hubs, networks, computing devices, processors, the like, or any combination thereof located external of the audio device, computing device, or both. The one or more communication modules may include one or more wired communication modules, wireless communication modules, or both. A wired communication module may be any module capable of transmitting and/or receiving one or more data signals via a wired connection. One or more wired communication modules may communicate via one or more networks via a direct, wired connection. A wired connection may include a local area network wired connection by an ethernet port. A wired communication module may include a PC Card, PCMCIA card, PCI card, the like, or any combination thereof. A wireless communication module may include any module capable of transmitting and/or receiving one or more data signals via a wireless connection. One or more wireless communication modules may communicate via one or more networks via a wireless connection. One or more wireless communication modules may include a Wi-Fi transceiver, a Bluetooth® transceiver, an infrared transceiver, a cellular transceiver, a radio frequency transceiver, the like, or a combination thereof. A cellular transceiver may be configured for connecting with a 4G LTE, 4G, 5G, and the like. One exemplary configuration may be that both an audio device and computing device (e.g., mobile device) each have Bluetooth transceivers as communication modules and communicate with each other over Bluetooth. Bluetooth may be advantageous for data transfer between the two devices as Bluetooth provides for beneficial security and encryption and requires the devices to be in close proximity to one another. Another exemplary configuration, a computing device may be in communication with one or more application interfaces via one or more cellular transceivers, Wi-Fi transceivers, or both. It may be beneficial to operate over cellular, as this avoids configuring an internal network and Internet access point at a user's location, avoid security risks with an internal network, or both. But Wi-Fi may also present advantages in being readily accessible and easy to use, such as in locations with poor cellular service.

The verbal workflow management system of the present disclosure may be integrated and/or include one or more networks. The computing devices, audio devices, or both may be in selective communication with one or more networks. The one or more networks may be formed by placing two or more computing devices, audio devices, or both in communication with one another, an application interface, a communication hub, the like, or any combination thereof. One or more networks may include one or more communication hubs, communication modules, computing devices, audio devices, processors, databases, servers, memory storage devices, the like, or any combination thereof. One or more networks may be free of and/or include one or more communication hubs (e.g., router, wireless router). One or more computing devices of the system may be directly connected to one another without the use of a communication hub. One or more networks may be connected to one or more other networks. One or more networks may include one or more local area networks (“LAN”), wide area networks (“WAN”), virtual private network (“VPN”), intranet, Internet, cellular networks, the like, or any combination thereof. The network may be temporarily, semi-permanently, or permanently connected to one or more computing devices, or any combination thereof. A network may allow for one or more computing devices to be connected to the computing device to transmit one or more data signals to the one or more computing devices, receive one or more data signals from the one or more computing devices, or both. The network may allow for one or more computing devices to receive one or more data entries from and/or transmit one or more data entries to one or more storage media. The network may allow for transmission of one or more signals, status signals, data entries, instruction signals, or any combination thereof, for processing by one or more processors.

The verbal workflow management system may include one or more interaction interfaces. One or more interaction devices may function to transmit and/or relay one or more data signals, data entries, or both from one or more computing devices, processors, storage mediums, databases, or a combination thereof to one or more other computing devices, processors, storage mediums, databases, or a combination thereof. One or more application interaction interfaces may function to exchange data from an application on one computing device to other remotely located computing devices (e.g., cloud computing). One or more interaction interfaces may include one or more application programming interfaces (API). The one or more interaction interfaces may utilize one or more architectures. The one or more architectures of an interaction interface may be one or more web service architectures useful for requesting, receiving and/or transmitting one or more data signals, data entries, or both from one or more other remotely located computing devices connected via one or more networks (e.g., web-based resources). One or more web service architectures may include Representation State Transfer (REST), gRPC, the like, or any combination thereof. One suitable interaction interface may be API Gateway by Google Cloud, incorporated herein by reference in its entirety for all purposes. Another exemplary interaction interface may be Amazon API Gateway™ provided by Amazon Web Services®, incorporated herein by reference in its entirety for all purposes. The one or more interaction interfaces may utilize one or more protocols for transmitting and/or receiving one or more data signals, data entries, or both. One or more protocols may include simple object access protocol (SOAP), hypertext transfer protocol (HTTP), user datagram protocol (UDP), message queuing telemetry transport (MQTT), the like, or any combination thereof.

The verbal workflow management system may include one or more processors. The one or more processors may function to analyze one or more signals related to data from one or more databases, storage mediums, microphones, transceivers, audio devices, computing devices, applications, or any combination thereof. The one or more processors be part of, separate from, or both relative to one or more components of the verbal workflow management system. One or more processors may be located within an audio device, outside of an audio device, within a computing device, part of a server of the system, or any combination thereof. One or more processors may be in communication with one or more other processors. The one or more processors may function to process data, convert data signals to data entries, execute one or more steps for relaying work instructions to a user, execute one or more steps for receiving new work instructions or amending existing work instructions, execute one or more algorithms to analyze data, apply one or more rules, evaluate data against one or more rules, or any combination thereof. Processing data may include receiving, transforming, outputting, executing, the like, or any combination thereof. One or more processors may be part of one or more hardware, software, systems, or any combination thereof. One or more hardware processors may include one or more central processing units, multi-core processors, front-end processors, microcontrollers, the like, or any combination thereof. The one or more processors may include one or more cloud-based processors. A cloud-based processor may be part of or in communication with one or more transceivers, interaction interfaces, audio devices, servers, networks, storage mediums, computing devices, the like, or a combination thereof. A cloud-based processor may be located remote from one or more audio devices, a computing device, one or more other processors, one or more databases, or any combination thereof. Cloud-based may mean that the one or more processors may reside in a non-transient medium located remote from one or more audio devices, computing devices, processors, databases, or any combination thereof. One or more cloud-based processors may be accessible via one or more networks. The one or more processors may convert data signals to data entries to be saved within one or more storage mediums. The one or more processors may access one or more algorithms to analyze one or more data entries and/or data signals.

The verbal workflow management system may include one or more storage mediums. The one or more storage mediums may function to receive and/or transmit one or more data entries from one or more components of the system, store one or more algorithms, store computer-readable instructions (e.g., software programs), or any combination thereof. The one or more storage mediums may include one or more storage devices, memory storage devices, or both. The one or more storage devices may include one or more non-transient storage devices. A non-transient storage device may include one or more physical servers, virtual servers, physical computing devices, or a combination thereof. One or more servers may include one or more local servers, remote servers, or both. One or more storage mediums may include one or more hard drives (e.g., hard drive memory), chips (e.g., Random Access Memory “RAM”), discs, flash drives, memory cards, the like, or any combination thereof. The one or more storage mediums may be located within one or more audio devices, servers, computing devices, the like, or a combination thereof. The one or more storage mediums may be in communication with one or more processors. The one or more storage mediums may receive data entries from one or more processors, may transmit one or more data entries to one or more processors, or both. The one or more storage mediums may store data in the form of one or more databases. The system may store a majority, if not all, of the data, algorithms, or both in a storage medium separate from a user's audio device, computing device, or even same onsite location. The system may be advantageous by providing offsite and secure cloud-based storage that is quickly and securely accessed.

The system may include one or more databases. One or more databases may function to receive, store, and allow for retrieval of information related to one or more work instruction data entries, user roles and authentication, time and performance, feedback, real-time translation, the like, or a combination thereof. The one or more databases may be located within (e.g., stored) one or more storage mediums. The one or more databases may include any type of database able to store digital information. The digital information may be stored within one or more databases in any suitable form using any suitable database management system (DBMS). Exemplary storage forms include relational databases (e.g., SQL database, row-oriented, column-oriented), non-relational databases (e.g., NoSQL database), correlation databases, ordered/unordered flat files, structured files, the like, or any combination thereof. The one or more databases may store one or more classifications of data models. The one or more classifications may include column (e.g., wide column), document, key-value (e.g., key-value cache, key-value store), object, graph, multi-model, or any combination thereof. An exemplary row-oriented database may include a comma-separated values (CSV) file. One or more databases may be located within or be part of hardware, software, or both. One or more databases may be stored on a same or different hardware and/or software as one or more other databases. The databases may be located within one or more non-transient storage mediums. One or more databases may be located in a same or different non-transient storage device as one or more other databases. The one or more databases may be accessible by one or more processors to retrieve data entries for analysis via one or more algorithms, store one or more data entries, or both. The one or more databases may be one or more cloud-based databases. Cloud-based may mean that the one or more databases may reside in a non-transient storage medium located remote from one or more computing devices, mobile training devices, servers, or a combination thereof. One or more cloud-based databases may be accessible via one or more networks. One or more databases may include one or more databases capable of storing one or more data entries related to one or more work instructions, translated work instructions, user privileges, performance of one or more workflows, the like, or a combination thereof. One or more databases may include one or more administrative databases, user privilege databases, work instruction databases (e.g., repository of work records for performing workflows), performance databases (e.g., repository of performance of a work record associated with a workflow), feedback database (e.g., repository of feedback of a work record associated with a workflow), the like, or any combination thereof. Data entries within one or more databases may include user data, organization data, record identification data, work instruction data, performance data, feedback data, the like, or any combination thereof.

The system may include one or more algorithms. The one or more algorithms may function to relay and/or analyze one or more signals, execute one or more processes, execute one or more routines, store data in one or more databases, the like, or any combination thereof. The one or more algorithms may include one or more processes, routines, or both. The one or more algorithms may be the software which allows for the system to operate. The one or more algorithms may be stored on and/or be accessible by one or more computing devices. The one or more algorithms may be accessed by one or more processors from one or more storage mediums. The one or more algorithms as a whole, or portions thereof, may be automatically executed. One or more processors may execute the one or more algorithms. A part of, portions of, or a whole algorithm may be completed on one computing device or spread among a plurality of computing devices. For example, a portion of an algorithm may be executed locally via an application on a computing device of a user while another portion of an algorithm may be executed remotely via a server (e.g., cloud computing). A single computing device may execute an entire algorithm. The one or more processes may include: an administrative process, a workflow configuration process, a report process, the like, or a combination thereof. The one or more routines may be considered one or more programming loops. The one or more routines may include: a login routine, a request routine, a step routine, the like, or a combination thereof.

Administrative Process—An administrative process may allow for functionality of the system to be configured by an administrator. The administrator may have administrative privileges, access to an administrative computer. The administrator may configure organizations, workflows, curricula, users, devices, roles, the like, or any combination thereof.

Workflow Configuration Process—A workflow configuration process may allow for functionality of the system to be configured by an administrator. The administrator may have administrative privileges, access to an administrative computer. Configuring workflow may be part of or separate from the administrative process. The administrator may configure one or more workflows. The administrator may assign one or more workflows to one or more organizations, entitle one or more workflows, create one or more workflows (e.g., standard operating procedures, work instructions), set one or more minimum performance levels for one or more workflows (e.g., steps of a workflow, overall workflow), the like, or a combination thereof.

Report Process—The verbal workflow management system uses performance interval data it automatically collects to reveal and report performance improvement opportunities across client organizations. Each report in the workflow management system is democratized and anonymized by user permissions. In reports, Administrators can see the real names of all users or avatars for all users or a combination of real names and avatars for users in their organization. In reports, Super-users can only see the real names of their direct reports but can opt to see all avatars instead of real names or a combination of real names of their direct reports and avatars of all other users. In reports, every User can operate all reports but cannot see the real names of users; they only see avatars, including their own. Users query the verbal workflow management system's database to focus on an individual user, workflow, or workflow step within a range of performance dates, user experience ranges, location, and organization segment.

Login Routine—To access one or more workflows according to the system herein, one or more routines may include a login routine. The login routine may allow for one or more users to access the verbal workflow management system.

Request Routine—One or more routines may include one or more request routines. One or more request routines may allow a user to verbally request one or more available workflows. One or more workflows may be requested by their title or another identifier.

Step Routine—The verbal workflow management's step routine verbally plays each step of a workflow to an operative device and/or peripheral such as an earphone, headphone, motion sensing, or other device, until the entire workflow is completed, performance intervals for each step have been collected, and optional continuous improvement feedback has been captured. When a workflow is completed, user information and all performance data and feedback related to the completed event are saved to the server in a unique “Performance Record”. There is 1 performance record for each time a workflow was initiated. Workflow navigation is accomplished via electronic or mechanical button presses or speech or motion or other trigger action on the operative device or a peripheral device. The trigger signal is sent by the operative software, to the server, where the signal is converted to a database command, which is executed by services on the server. When executing a command, services on the server translate workflow steps aka database text fields one-at-a-time to the user's language if the service is necessary and available, converts the text to speech, starts a timer, transmits the audio through a Wi-Fi, Bluetooth, cellular or other network to an operative device, then waits for a trigger to perform a new command. Commands include: Help, Feedback, Previous, Repeat, Next, and Quit. The Help command can be triggered at any point of any workflow. When triggered, the Help command immediately sends an email message to the user's designated supervisor. The Feedback command may be triggered at any point of any workflow. Feedback is always solicited at the end of every workflow but is optional and can be bypassed by users. Providing feedback is done verbally and, when provided, the Feedback field of the event's performance record is updated. The Previous command plays the penultimate step of an ongoing workflow. The Repeat command replays the current step of a workflow. The Next command plays the workflow step following the current one. Quit ends the workflow and recycles the operative software to the Request routine.

The system primarily uses a wake phrase and command words to navigate database records. Navigating database records entails requesting a standard operating procedure to perform, quitting a standard operating procedure, ending one procedural step and beginning another, repeating a step, requesting help, and providing feedback. The system may al so allow users to trigger most functions by pressing a mechanical button on a headphone, earphone, mobile device, or peripheral such as a digital pen, by making specific motions such as foot tap, hand swipe, or head nod.

The system automatically captures valid, unbiased, and when used often enough, reliable performance interval data. The system's analytics enable users to query captured data to reveal continuous improvement opportunities across the organization and down to individual user and process step detail. Those opportunities include individualized coaching, process improvement at step detail, equipment needs, policy change, compensation adjustment, staffing optimization, and more. Users can sort and aggregate data from the performance database records via any field in the system including worker name, location, division, performance date range, user experience, hire data, and other variables.

The verbal workflow management system requires verbal commands to operate some functions including workflow requests and providing feedback. It optionally allows users to perform all other operational functions via voice. To enable this, the operative software, constantly analyzes or “listens” to environmental sounds for a pre-programmed “wake word” or “wake phrase”, then a command. This is accomplished with operational software, services from an operative device, optional peripheral functions, and server services including speech recognition and text-to-speech. Ideally, the wake word or wake phrase is an uncommon series of phonemes. For example, the wake phrase, “Hey Coach” contains 5 phonemes but could be any combination of words or sounds. Upon detecting the 5 phonemes in “Hey Coach”, the operative software listens for a word or phrase pre-programmed to trigger an action relative to the current program routine. For clarity, while in the Request routine, the operative software only anticipates workflow titles, while in the Feedback routine, the operative software only anticipates the command, “Feedback”, then freeform speech. In the Step Routine, the operative software anticipates the commands, “Next”, “Repeat”, “Previous”, “Help”, “Feedback”, and “Quit.”

The present hardware, software, and system may include one or more components, algorithms, or any combination thereof of the mobile training device and mobile device training system as described in U.S. Pat. No. 9,595,201 and US Publication No. 2019/0267002, incorporated by reference in their entirety for all purposes.

### ILLUSTRATIVE EXAMPLES

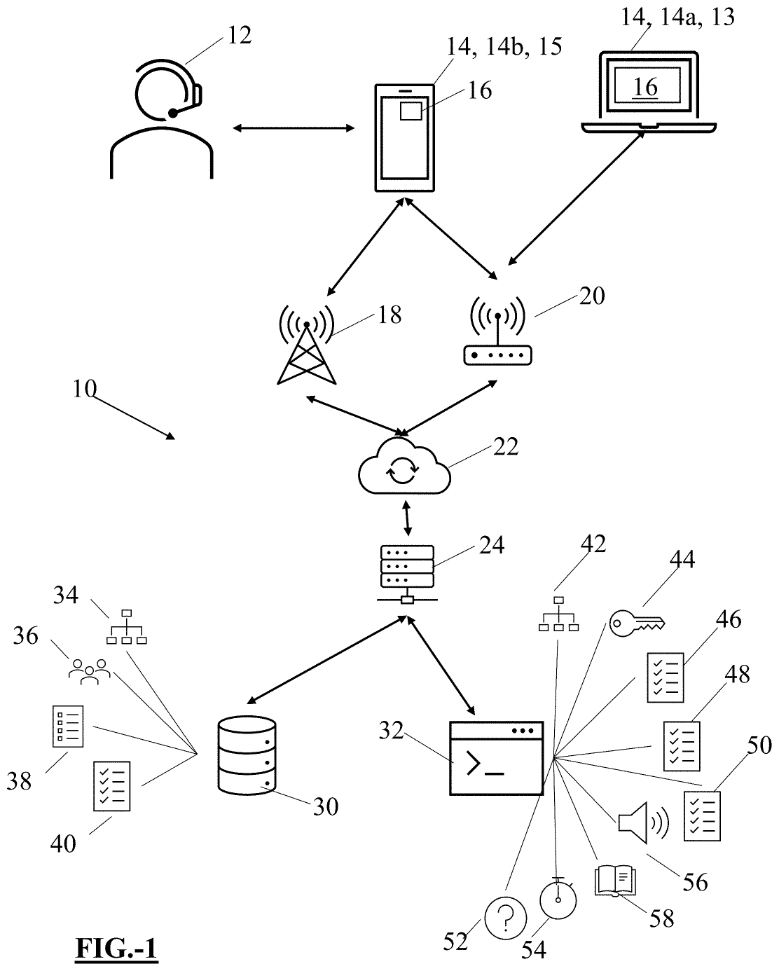

FIG. 1 illustrates a verbal workflow management system 10. The system 10 includes a headset 12 in communication with a computing device 14. The computing device 14 is in the form of a mobile device 15. The mobile device 15 may include an application 16 stored thereon or accessible therefrom. The mobile device 15 may be referred to as a second computing device 14b with a second user interface. The mobile device 15 is in communication with the Internet 22, such as through a communication tower 18 or router 20. The system 10 includes another computing device 14. The computing device 14 is in the form of a computer 13, such as a laptop or desktop computer. This device may be referred to as a first computing device 14a with a first user interface. The first computing device 14a may also be an administrative computer. The computer 13 may include an application 16 stored thereon or accessible therefrom. Via the Internet, the application 16 is able to access one or more servers 24. The one or more servers 24 includes or is in communication with one or more databases 30, algorithms 32, or both. The one or more servers 24 may include or be in communication with one or more processors, storage mediums, or both. The one or more processors may access and execute the one or more algorithms. The one or more processors may access, edit, and/or create data in the one or more databases, such as via the one or more algorithms. Exemplary databases 30 may include one or more administrative databases 34, user privilege databases 36, work instruction databases 38, performance databases 40, the like, or any combination thereof. Exemplary algorithms 32 may include one or more administrative processes 42, login routines 44, workflow configuration process 46, request routine 48, step routine 50, performance query 52, timekeeping process 54, speech-to-text algorithm 56, translation algorithm 58, or any combination thereof.

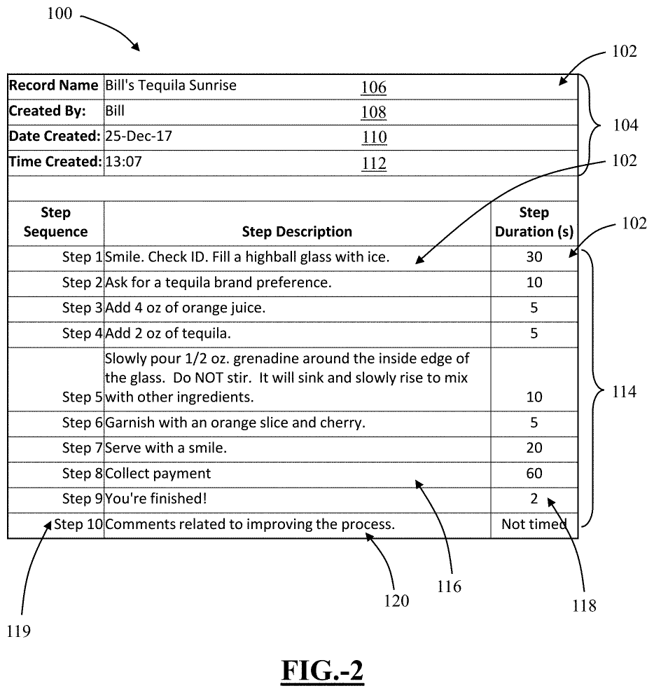

FIG. 2 illustrates a record 100. FIG. 2 may display how a record 100 is shown on a visual user interface 72 (not shown), such as that part of or connected to a computing device 70 (not shown). The record 100 includes a plurality of fields 102. The fields 102 include record identification data 104. The record identification data 104 includes a record name 106, creator 108, creation date 110, and creation time 112. The fields 102 include work instruction data 114. Work instruction data 114 includes individual steps 116 and a duration 118 of each step 116. The work instruction data 114 is sorted sequentially by step sequence 119 in the order the individual steps 116 should be completed. Work instruction data 114 further includes feedback data 120.

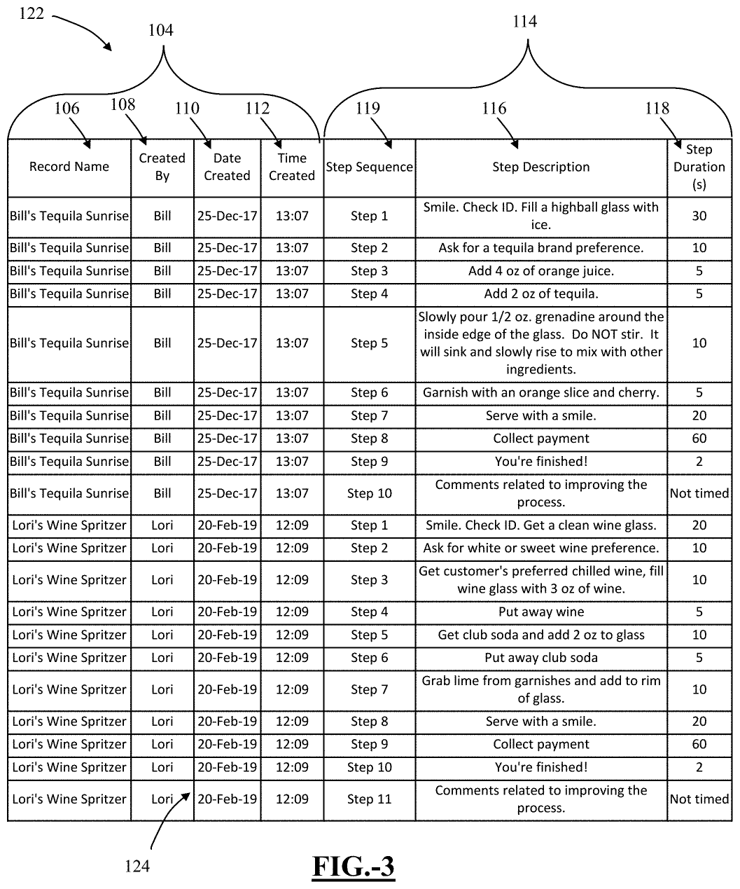

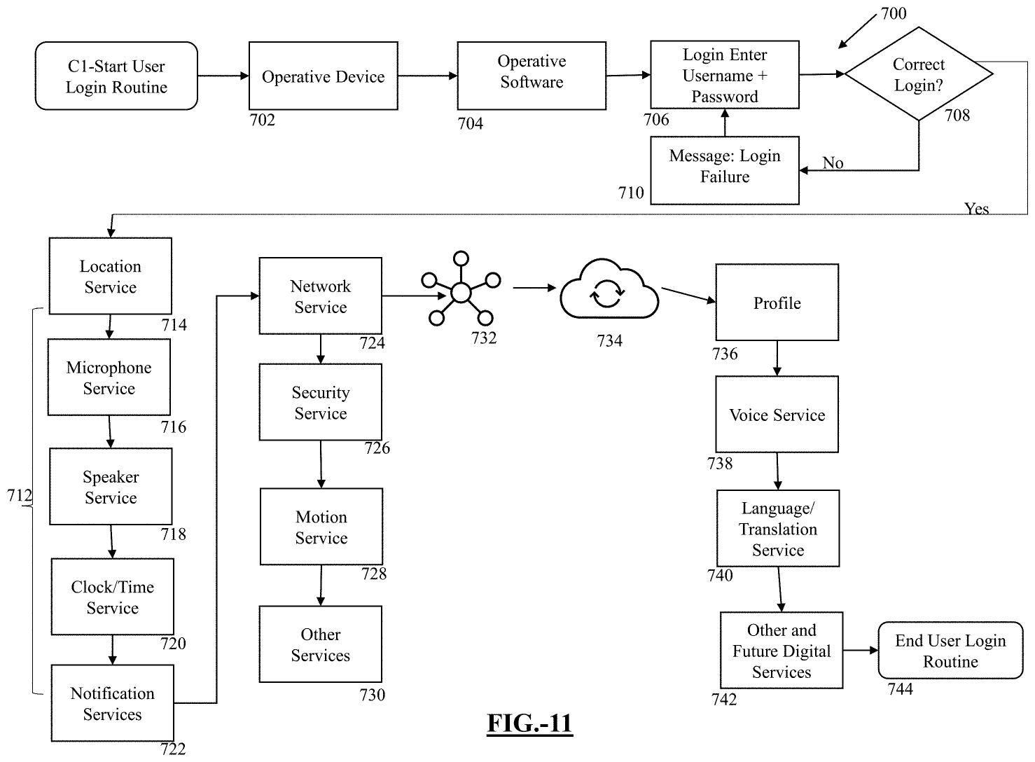

FIG. 3 illustrates a record database 122. The record database 122 includes all of the data displayed in one or more records 100. The record database 122 includes a plurality of data entries 124. The data within the data entries 124 may be the data then displayed in fields 102 of a record 100. Each data entry 124 includes record identification data 104. The record identification data 104 includes record name 106, creator 108, creation date 110, and creation time 112. The record identification data 104 identifies which data entry 124 is associated with a single record 100. For example, each data entry 124 with a record name 106 “Bill's Tequila Sunrise” is part of the record 100 as shown in FIG. 11. Each data entry 124 further includes work instruction data 114. The work instruction data 114 includes a step sequence 119, description of the individual step 116, and a duration 118 of the individual step 119. If the data entries 124 are recorded in one language but need to be saved in a second language, there may be a plurality of record databases 122. One record database 122 may be in the recorded language while a second, record database 122 may be in the common language. For example, the plurality of data entries 124 may be recorded in Spanish as saved in a record database 122. Via a translation algorithm 68 (not shown), the plurality of data entries 124 may be saved to a similar record database 122 but in a common language, such as English.

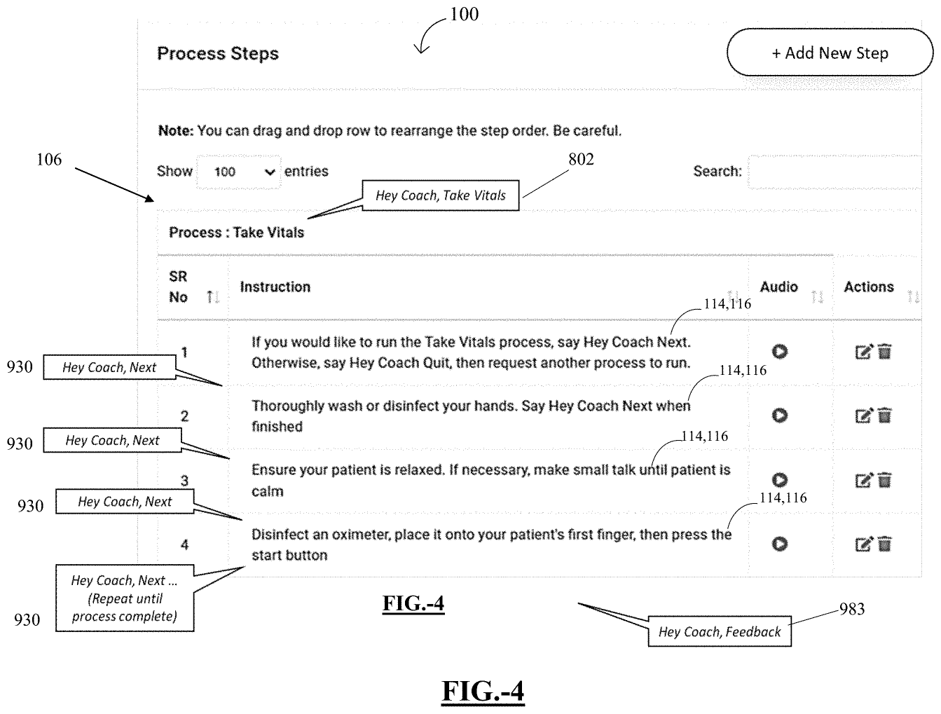

FIG. 4 illustrates an example of verbal commands during execution of a record 100. The record 100 is a workflow or a work instruction. The record 100 includes a record name 106, which is a title. The record includes work instruction data 114. The work instruction data 114 includes individual steps 116. A user may initiate audible playing of the record work instruction steps 116 by first requesting the record or routine 802. For example, the user may verbally request the record by its title to an audio device of or affixed to a computing device. The user may then have each step audibly played by providing a verbal next command 930. The user may provide feedback regarding an individual step or the whole routine by providing a verbal feedback command 983.

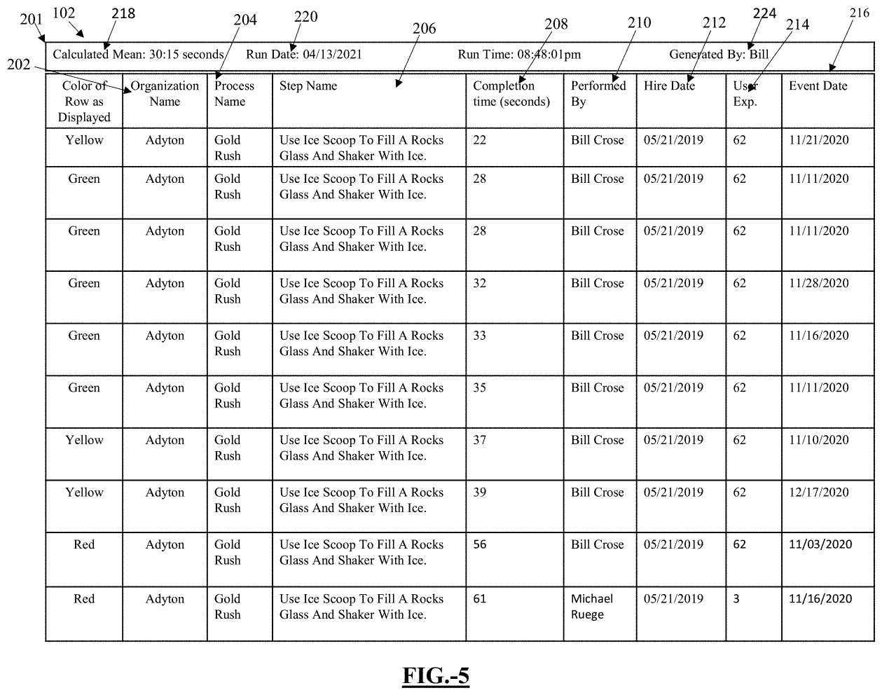

FIG. 5 illustrates a performance report 200. The performance report 200 may have a plurality of fields 102. Some of the fields may provide for a header data 201. Header data 201 may include a calculated mean, mode, and/or median 218, date the report is executed 220, a time the report is executed 222, and even the user who executed the report 224. The fields 102 may include an organization name 202, process name 204, step name 206, completion time 208, user who completed the step 210, the user's hire date 212, the user's experience 214, and the date the step was completed by the user 216. Upon displaying, the report 200 may include each performance interval of the found dataset relative to the mean or median or mode performance interval. For example, steps with performance within the 3rd and 4th standard deviation may be highlighted green Gn. For example, steps with performance within the 2nd and 5th standard deviations may be highlighted gold Gd. For example, performance within the 1st and 6th standard deviations may be highlighted red Rd.

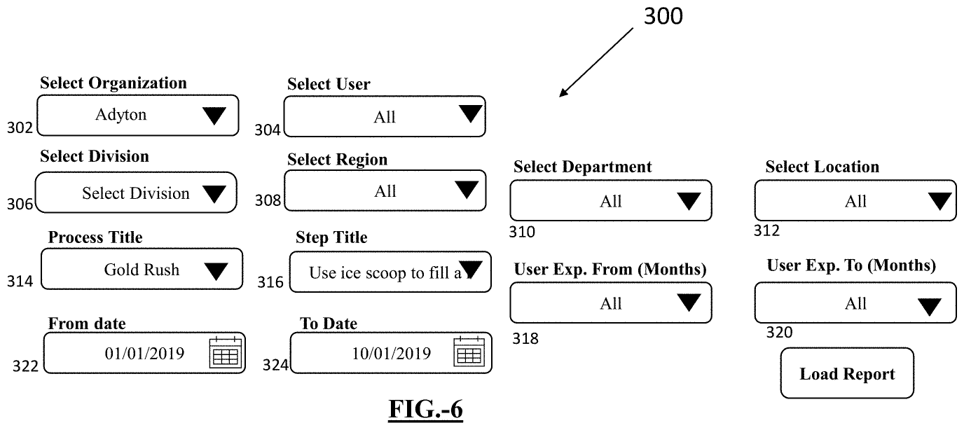

FIG. 6 illustrates a performance report querier 300. The querier 300 may be allow for filtering and sorting for certain records to execute a performance report. The querier 300 may have one or more fields 102 matching with one or more fields of a record, performance report, feedback report, any other databases of the system containing desired data, the like, or any combination thereof. The one or more fields may include organization 302, user 304, division 306 region 308, department 310, location 312, process title 314, step title 316, user experience start date 318, user experience end date 320, performance start date 322, performance end date, 324. The performance report querier 300 may be displayed via an application 16 onto an interface of a computing device 14.

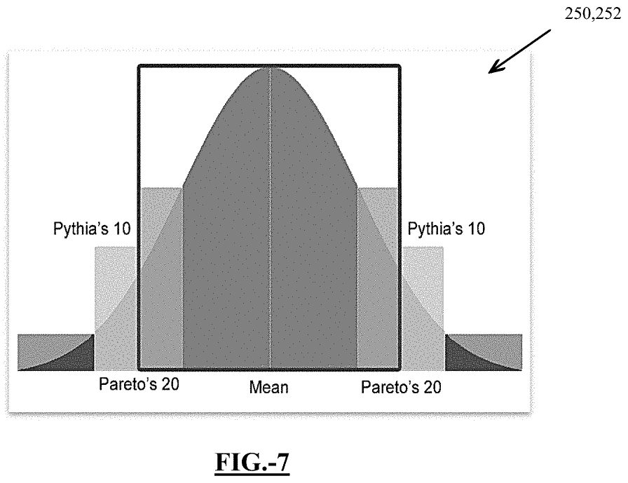

FIG. 7 illustrates a performance curve 250. The performance curve 250 is provided as a bell curve 252. The performance curve 250 summarizes results of a performance report 200. The bell curve 250 may be displayed as part of, in addition to, or in lieu of a performance report 200. The performance curve 250 may be displayed on an interface associated with an application 16 (not shown) running on a computing device 14 (not shown).

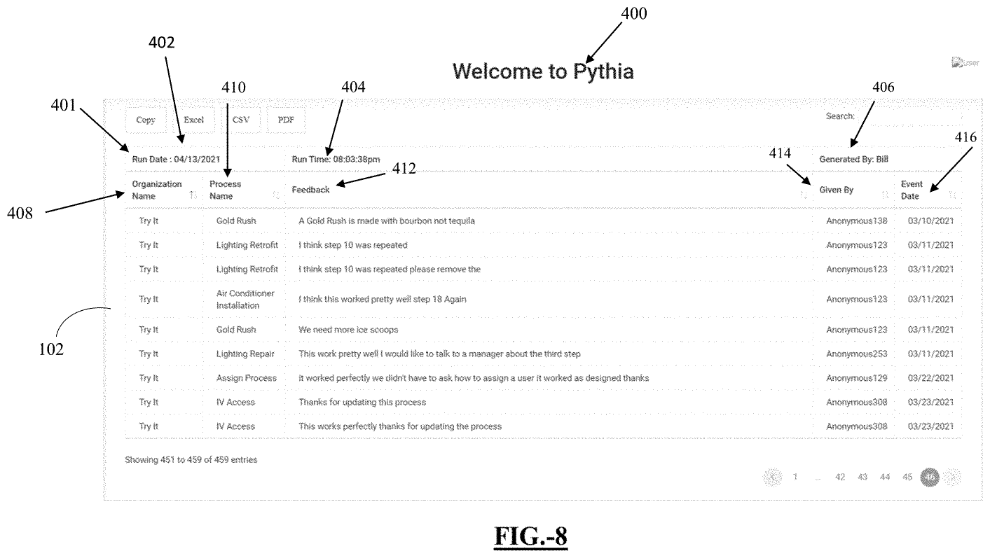

FIG. 8 illustrates a feedback report 400. The feedback report 400 captures feedback provided by a user during and/or after executive of one or more workflows. The feedback report 400 includes a plurality of fields 102. The fields 102 include header data 401. Header data 401 includes a date the report is executed 402, a time the report is executed 404, and which user generated the report 406. The plurality of fields 102 include an organization name 408, a process name 410, a feedback record 412, a user which provided feedback 414, and an instance date 416. The feedback record 412 may be the feedback collected during a feedback command 983.

A feedback report 400 may be generated such as through a report querier similar to the performance report querier 300.

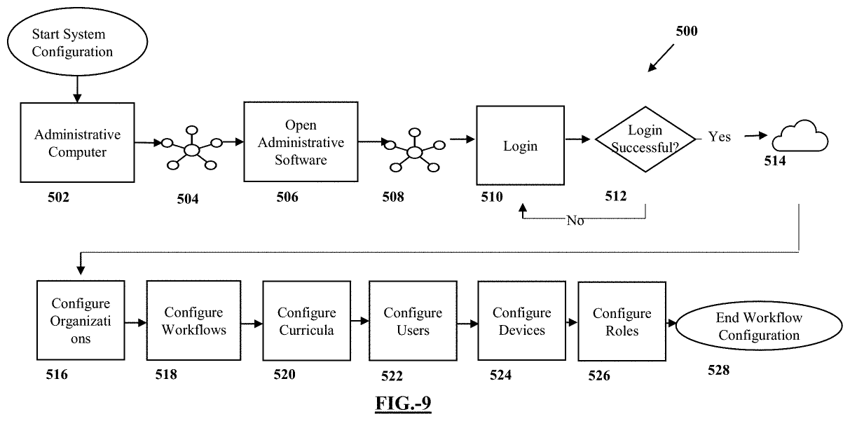

FIG. 9 illustrates an administrative process 500. The verbal workflow management system requires a user accessing a computing device which is an administrative computing device 502, such as a laptop computer, desktop computer, tablet, or similar hardware. The administrative computing device 502 is in communication with a network 504. For example, networks may be Bluetooth, Wi-Fi, cellular, or similar current or future networks capable of transmitting and receiving digital information. A user opens administrative software 506 via the administrative computing device. The administrative software 506 may be accessible via, partially stored, or fully stored on the administrative computer, another computing device, locally on the same network, remotely, or any combination thereof. The administrative software 506 may access the network to access remotely stored information 508. A user may login 510. The login credentials are validated 512. If the credentials are acceptable, the administrative software on the administrative computing device is granted access to the workflow management software 514. The workflow management software 514 may reside on one or more servers, such as one or more remote (i.e., cloud) servers. The user may then be able to configure one or more organizations 516. One or more organizations may be one or more different entities, suborganizations, departments, and/or the like associated with an administrative user (e.g., the user's business entity). Once or more organizations are created, one or more workflows are configured 518. One or more workflows may be created such as illustrated in FIGS. 2-4 and 10. The user may configure one or more curricula 520. This may mean assigning certain workflows to certain organizations and/or users, grouping workflows together which should be learned by a user, and/or the like. The user may configure one or more users 522. Configuring users may mean creating user credentials; assigning users to organizations, workflows, and/or curricula; or any combination thereof. The user may then configure one or more devices 524. Configuring the devices may mean allowing the devices access to the system, connecting them to the network, setting certain security settings, and the like. The user may then configure one or more roles 526. The roles may allow for different users to have different access privileges into the system. Some users may have administrative access, creation access, edit access, read access, and/or the like. The administrative process may then end 528. While the administrative configuration steps 516-526 are illustrated in one order, they may be completed in any order after successfully logging in 512. Each configuration step does not have to be completed during each administrative process.

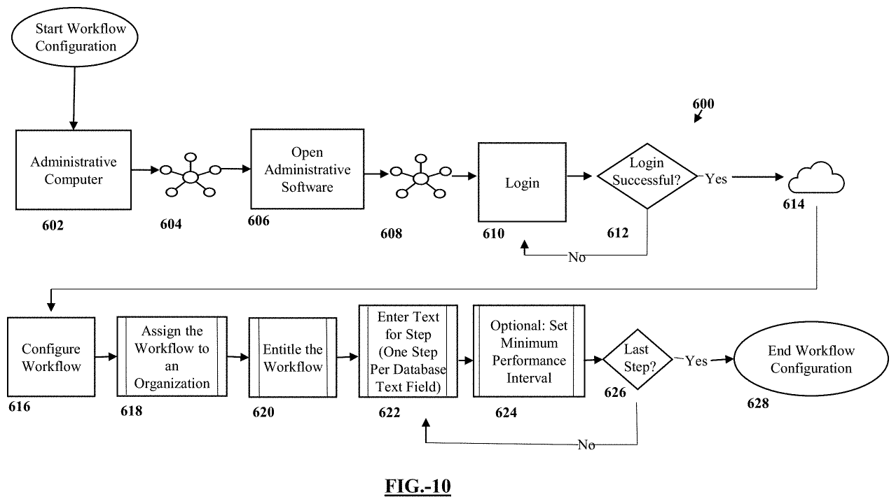

FIG. 10 illustrates a workflow configuration process 600. The workflow configuration process 600 commences by a user logging into an administrative computer 602. The administrative computer 602 is connected to a network 604. The user opens the administrative software 606. The administrative software is in communication with the network 608. The user logs in 610 to the administrative software. The login credentials are validated 612. Once validated, the user is granted access into the administrative software 614. The user begins configuring a workflow 616. The configure a workflow, the user assigns the workflow to an organization 618. Then user may then entitle the workflow 620. The user may then enter in each step for a work instruction 622. The work instruction may be entered in via keyboard input, audible input (text-to-speech), or both. The user may enter in the sequence associated with each step, a duration associated with each step, or both. The user may optionally enter in a minimum expected performance level for a work instruction, as a whole and/or individual steps, 624. Performance level may mean duration. Once the last step for a work instruction is entered 626, the workflow configuration may end 628. Editing a workflow (work instruction) may resemble a similar process when using an administrative computer.

Further exemplary workflow configurations are provided in U.S. Pat. No. 9,595,201 and US Publication No. 2019/0267002, incorporated by reference in their entirety for all purposes.

FIG. 11 illustrates operation of a login routine 700. To access the verbal workflow management system via a computing device, such as a mobile device, users must follow a login routine. To log in, a user powers on the operative device 702, if not already powered. The user will then access an application associated with the verbal workflow management system 704. For example, a user on a mobile device may access a mobile application the mobile device. The user will then enter log-in credentials into the application 706. Log-in credentials may include a unique username and password associated with their user profile to access the verbal workflow management software via the application. The log-in credentials are validated 708. If the login is incorrect, a failure message is given 710. If the login is correct, the application accesses and initiates one or more services 712 provided by the computing device's operating system. The one or more services may include location service 714, microphone service 716, speaker service 718, clock/timer service 720, notification service 722, network service 724, security service 726, motion service 728, and other current or future available services 730. With services engaged, the application accesses a network services 732. The network service then accesses one or more servers 734 associated with the verbal workflow management system. Upon connecting with the one or more servers 734, the application loads information from the user's profile 736. Information from a user's profile may include their organization, preferred language, assigned workflows, assigned curriculum, and other current and future user information. Further, additional services may be access, including voice services 738, language translation service 740, and other current and future services 742. When the application's language translation service 740 is activated, users may verbally interact with the operative system in their preferred language and all speech generated by the application may be delivered in the user's preferred language. After the application has loaded the user's profile 736 and initiated all the services needed 738 to 740, the login process is successfully completed 744 and the user can advance to the request routine.

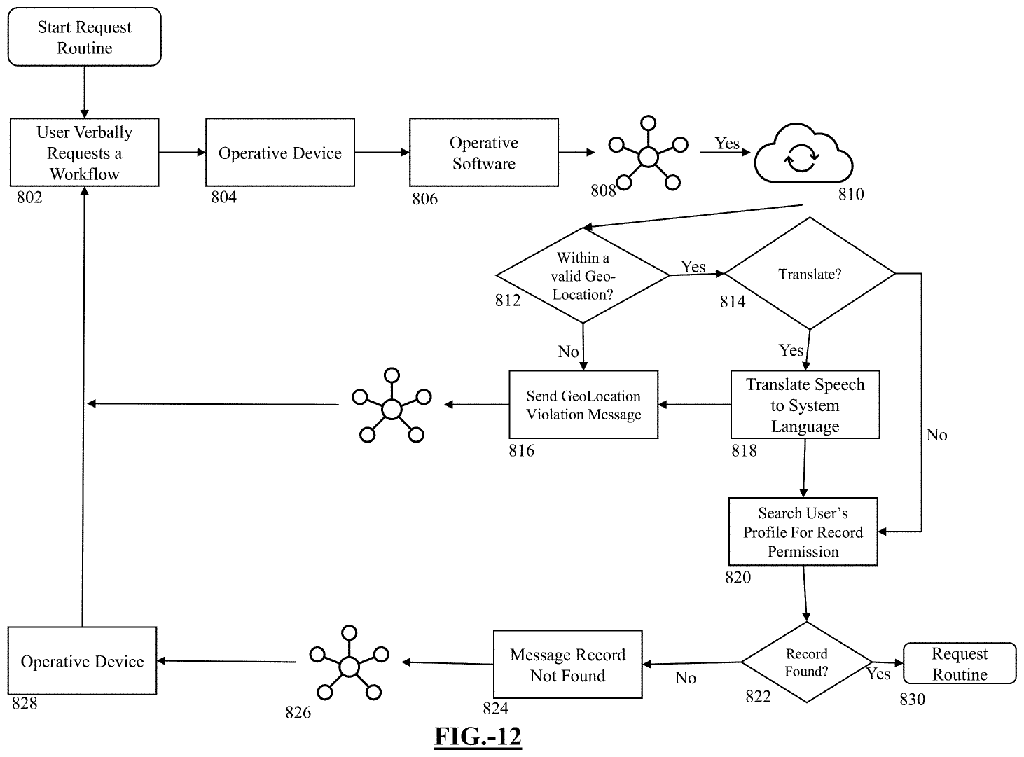

FIG. 12 illustrates a request routine 800. Users request workflows by speaking the desired workflow's title 802 into an audio device in communication and/or part of a computing device having the application thereon. The title should be as or substantially similar to how the title appears in a work instruction record on a server of the verbal workflow management system. Upon verbally requesting a workflow title, the computing device captures the user's speech 804. The user's speech is then transmitted to the application 806. The application passes the audio pattern through a digital network 808. From the network, the audio pattern is transmitted to one or more servers of the system 810 where it is then converted to text. The text may be translated from the user's preferred language to the system's language if necessary and if translation service is available.

The application checks to be sure the user is making the request within an approved geolocation 812. For security purposes, the system may forbid users from accessing workflow outside specific geolocations as configured by administrators. If the user is not making the request from an approved location, the application sends a geolocation error message to the user 816, then recycles to the beginning of the routine. If the user is in an approved location, the application checks to see if the request can and should be translated into the system language 814. A geolocation may be determined such as by location services of a computing device (e.g., location services of a mobile phone).

If the request can and should be translated, the request is translated to the system language 818. After evaluating the need for translation and potentially translating, the software at the one or more servers search for the user's permission to access the workflow/record on the server 820. For example, the software may search for a workflow/record which is assigned directly to the user and/or assigned to the user via the user's curriculum. As illustrated earlier, workflows are assigned to users via an administrator. Users may only be allowed to access workflows to which they have privileges.

If the record was found 822, then the request routine process ends 830.

If the record was not found 824, the system delivers a “Record not found” message 824. The message is delivered from the one or more servers via the network 826. Then from the network to the computing device 828. The request routine process 800 commences back at the beginning so users can request a new or intended workflow 802.

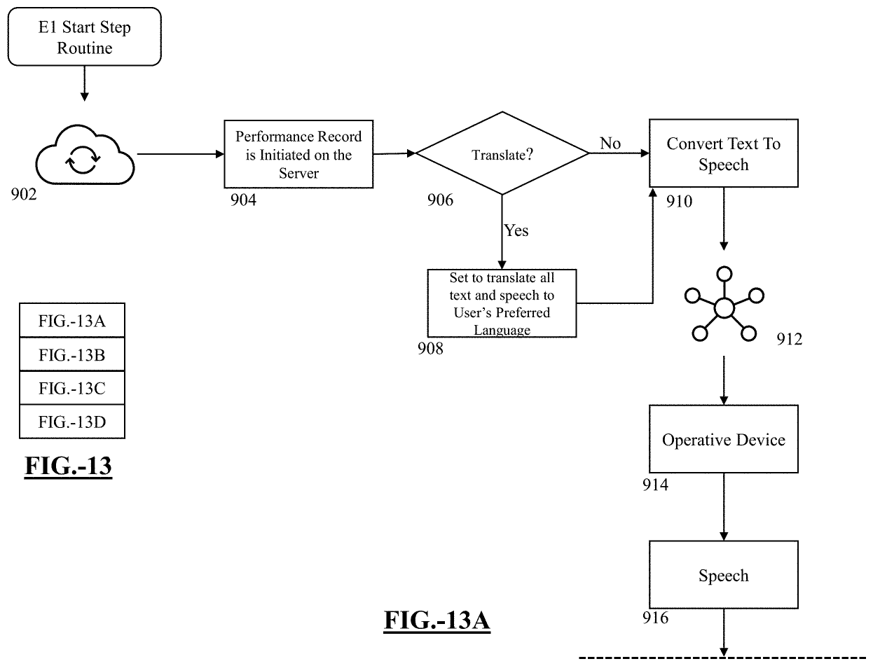

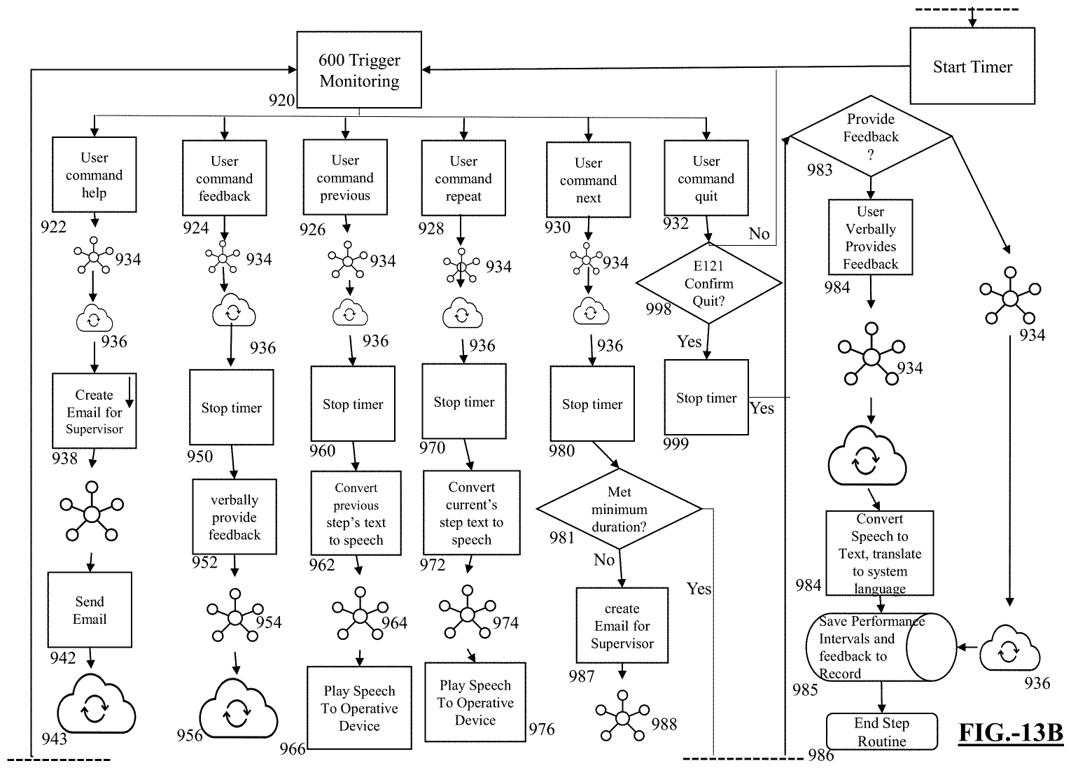

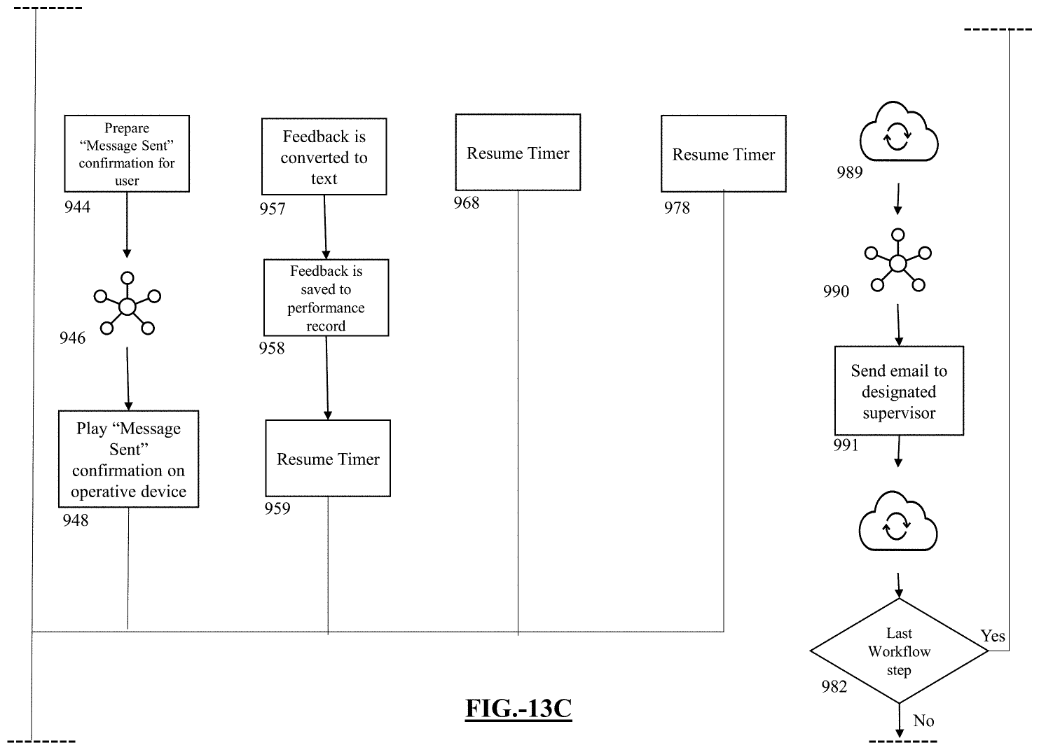

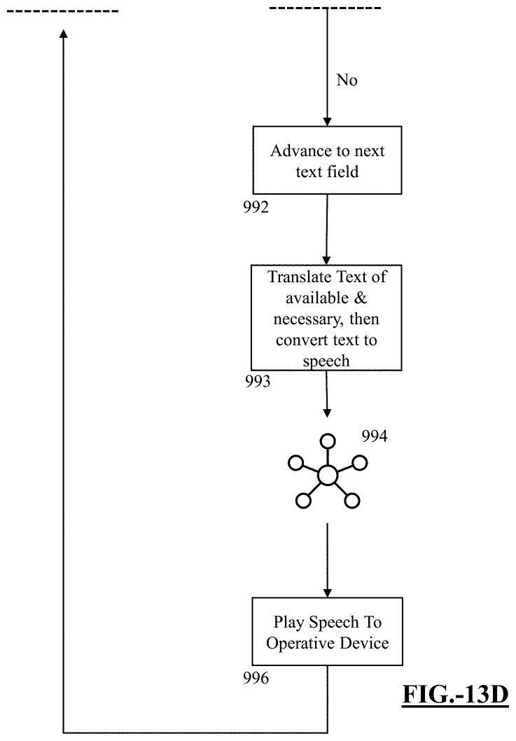

FIGS. 13A-13D illustrate a step routine 900 in operation. The verbal workflow management system's step routine 900 only begins after the request 800 (such as illustrated in FIG. 12) has successfully found a requested workflow on the server 902. After locating the requested workflow, the system creates a performance record 904. The performance record is stored on the server, such as in a performance database. The server checks to see if translation is needed 906. Specifically, if translation is required from the system language to the user's preferred language. The server begins checking for translation by checking the first text field of a work instruction record. If translation is required, a translation step is generated 908. If no translation is required, the text is converted to speech without translation 910. The speech/audio data (e.g., in signal form) is passed through the network 912 and to the application 914. Depending on the computing device used, the speech/audio may or may not be saved to device memory, temporarily or permanently. The speech/audio is played through a speaker of the computing device or through an affixed audio device 916.

After the audio related to a step is audibly played, then a timer is started 918. The timer can be executed on the application or at the software on the server. Once the timer begins, the application or software at the server begins monitoring for command triggers 920. Triggers may be software commands that initiate various actions. Triggers may be initiated by voice commands, electronic or mechanical button presses, or both at an audio device, computing device, or both. The triggers and their actions include a Help Command 922, Feedback Command 924, Previous Command 926, Repeat Command 928, Next Command 930, and Quit Command 932.

Help Command 922—Creates, sends, and confirms the delivery of an email, SMS alert, or other electronic notification to the user's designated supervisor indicating the user's name, help request time, workflow title, workflow step title being performed, or combination thereof when the Help command is initiated. Upon being triggered at the computing device, the help command is passed through the network 934 and to the server 936. At the server, the electronic notification is automatically created. After the system creates the electronic notification, the notification data passes through the network 940 and is sent to the designated supervisor's contact information (email address, cell phone number, or other contact) 942. After delivering the electronic notification to the designated supervisor, the server 943 creates a message to confirm the notification was sent 944. The server creates the confirmation message, translates if the user has a preferred language different than the system language, and converts to speech data 944. The confirmation is formatted such as to indicate the help request notification was sent to a supervisor. The confirmation is then passed from the server to the network 946, then from the network to the computing device. Once received at the computing device, the confirmation message is automatically audibly played 948. Thereafter, trigger monitoring resumes 920.

Feedback Command 924—Enables users to optionally provide their continuous improvement feedback or other comments while performing a workflow and/or at the end of every workflow. The feedback command is passed from the application through the network 934 and to the server 936. Upon the server receiving the feedback command, the timer is stopped 950. The user speaks their feedback via into an audio device part of or affixed to the computing device 952. The speech is passed through the network 956 and to the server 958. At the server, the speech (data signals related to speech) is converted to text 957. The feedback in text form is then saved to the performance record for this instance 958. Instance is defined as the particular instance (time, date, user) a work instruction is performed. Once saved, the timer resumes 959. Once the timer resumes, then trigger monitoring resumes 920.

Previous Command 926—Enables users to hear the previous step repeated. The command is passed from the application to the network 934 and to the server 936. Once the command is received at the server, the server automatically stops the timer 960. After stopping the timer, the server automatically searches for and identifies the text field for the immediately preceding step, translated if needed to a user preferred language, then converts to speech 962. The verbal work instruction for the last step is passed via the network 964 to the application. Once received by the application, the last step is verbally played by an audio device part of or affixed to a computing device 966. After playing, the server automatically resumes the timer 968. After the timer resumes, trigger monitoring also resumes 920.

Repeat Command 928—Enables users to hear the current workflow step repeated. The command is passed from the application to the network 934 and then to the server 936. Upon being received by the server, the server stops the timer 970. The server once again, access the text field associated with the step of the work instruction, translates if necessary, converts text to speech 972. The server then passes the speech/audio data to the network 974 and to the application. The application then audibly plays the text on the audio device part of or affixed to the computing device 976. After replaying the step, the timer resumes 978. Thereafter, trigger monitoring also resumes 920.

Next Command 930—Enables users to hear the next workflow step, commence the next step, or both. The command is passed from the application to the network 934 then to the server 936. Once the command is received at the server, the timer is automatically stopped 980. Upon stopping the timer, the server automatically checks the performance level 981. For example, the server may check the time recorded by that timer and comparing to the minimum duration acceptable for the performance level.

If the performance level is not met, the system automatically generates an automatic notification to a supervisor of the user 987. The notification is generated at a server 987. The notification is transmitted from the server to the network 988. The notification may be received by another server 989 and network 990. The notification is then transmitted to the designated supervisor of the user 991. The notification may be any type of electronic notification such as an electronic email, SMS message, or other electronic notification. Once the notification is sent, the server automatically determines if this is the last workflow step 982. This can be determined if one or more other workflow steps follow the current step.

If the performance level is met (e.g., the recorded time meets or exceeds the minimum duration acceptable), then the server automatically determines if this is the last workflow step 982. This can be determined if one or more other workflow steps follow the current step.

If the system determines that the workflow step is not the last step, the system moves on to the next step of a workflow 992. Upon reaching the next step, the workflow may translate the text if necessary (e.g., user preferred language is different than system default language). Then the system may convert the text of the workflow step into speech, or rather speech data 996. The speech data is relayed over the network 994. Then from the network to a computing device where it is automatically verbally recited to a user 996. Thereafter, the trigger monitoring commences again 920.

If this is the last workflow step, the system asks the user if the user would like to provide continuous improvement feedback 983.

If the user provides a verbal command (e.g., “yes”) to providing feedback, the user provides audible feedback received by the audio device part of or affixed to the computing device 984. The audible feedback is transmitted via the network 934 to the server 936. The server receives the audible feedback, converts it to text, and optionally translates if necessary 984. The feedback is then stored into a performance record 985. Additionally, the performance interval (e.g., duration recorded by timer) for each step of the workflow is also saved into the performance record. Thereafter, the step routine ends 986.

If user provides a verbal command (e.g., “no”) to communication no desire to providing feedback, the command is relayed to the network 934 and then to the server 936. The application passes all saved data for this particular instance to the server. Then the data is saved to the performance record, including the performance interval 985. Thereafter, the step routine ends 986.

Quit Command 997—Enables a user to end a workflow at any time after it has started. After quitting a workflow, the operative system loops to the Request routine so a new workflow can be started. Immediately after receiving a quit command 997, the operative software asks the user to confirm they'd like to quit the workflow 998.

If a user confirms wanting to quit the workflow, the timer is stopped 999. After the timer is stopped, the system sends a feedback request 983. The feedback process may commence as described hereinbefore if the user desires to provide feedback 984. If no feedback is desired, then then saving of the data as a performance record is processed as described hereinbefore.

If the user determines not to quit the workflow, the workflow resumes and trigger monitoring resumes 920.

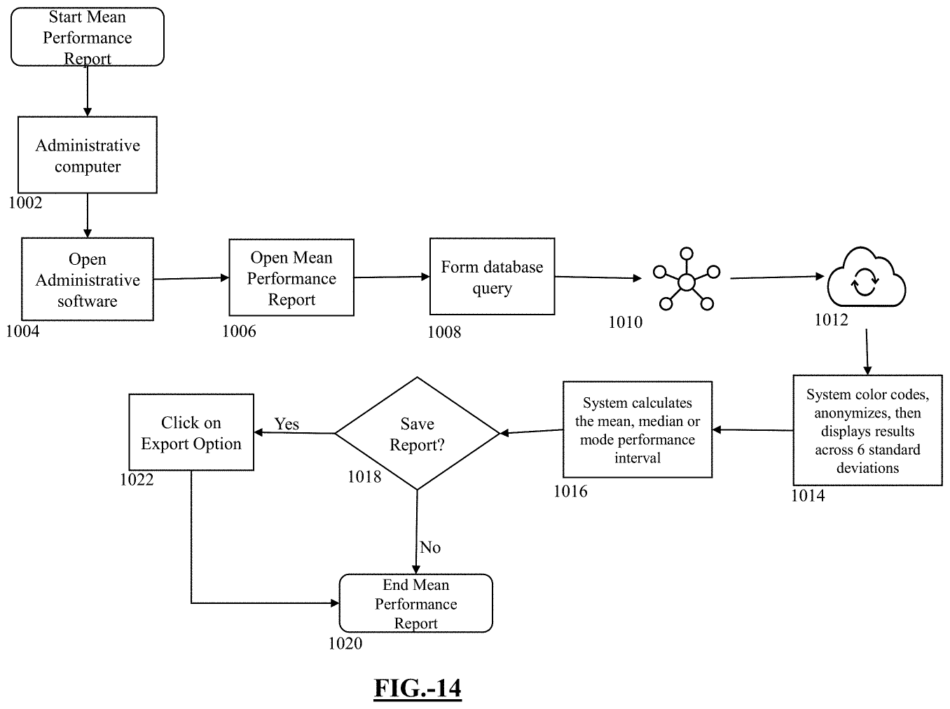

FIG. 14 illustrates a report process 1000. To operate a report in the verbal workflow management system, a user first accesses a computing device, such as an administrative computing device 1002. The user opens an application that allows for system administration via the computing device 1004. Within the application, the user creates one or more queries for one or more performance reports 1008. The one or more queries are transmitted through the network 1010 and to the server 1012. Upon being received by the server, the server automatically filters and sorts for the queried data and calculates performance data 1014. The server automatically generates a dataset. The server automatically generates one or more means, medians, modes, or combination thereof for a performance interval. After calculation of the performance data, the server automatically finalizes the data for display and displays the results 1016. Finalizing may include color coding, anonymizes, or both the resulting performance data and any underlying data. Displaying then include relaying the report data back through the server and network to the application and onto the interface of the computing device. Upon displaying, the report may include each performance interval of the found dataset relative to the mean or median or mode performance interval. For example, steps with performance within the 3rd and 4th standard deviation may be highlighted green. For example, steps with performance within the 2nd and 5th standard deviations may be highlighted gold. For example, performance within the 1st and 6th standard deviations may be highlighted red. Once the performance report is displayed, a user is provided with a prompt on the application to save the report 1018. To save a report, the User may click an on-screen export option 1022. After the report is exported, users may exit the reports function 1020. To not save a report, the user may leave the reports function of the application 1020.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” or “having” to describe combinations of elements, ingredients, components or steps herein also contemplates embodiments that consist essentially of, or even consist of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A method for configuring and executing one or more workflows including:
a) a processor receiving and automatically confirming administrative credentials and allowing a first user to access an application of a verbal workflow management system executed on a first computing device,
wherein the administrative credentials are entered by the first user having administrative privileges into the application via a first user interface of the first computing device, and
wherein the processor is remotely located from the first computing device;
b) the processor receiving and automatically storing a plurality of workflow data including one or more workflows and one or more organizations, one or more curricula, one or more users, one or more devices, one or more roles, or a combination thereof,
wherein the workflow data is configured by the first user via the first user interface,
wherein the one or more users include a second user, and
wherein the one or more roles include user privileges;
c) the processor receiving and automatically confirming user credentials and allowing the second user to access the application of the verbal workflow management system executed on a second computing device,
wherein the user credentials are entered by the second user having the user privileges into the application via a second user interface of the second computing device, and
wherein the second computing devices includes, is affixed to, and/or is in communication with an audio device having at least one speaker and one microphone, and
wherein the processor is remotely located from the second computing device;
d) the processor receiving a verbal request for one or more workflows,
wherein the one or more workflows are verbally requested by the second user into the microphone of the audio device as the verbal request, and
wherein the verbal request is transmitted from the second computing device;
e) the processor automatically identifying the one or more workflows which match the verbal request and transferring to the application of the second computing device; and
wherein upon receipt of the one or more workflows, the audio device audibly executes via the speaker one or more steps associated with the one or more workflows such that the second user hears the one or more steps as one or more verbal instructions and is able to commence performing one or more actions associated with the one or more steps to complete the one or more workflows.

2. The method of claim 1, wherein configuring the one or more workflows of the workflow data includes creating the one or more workflows, editing the one or more workflows, or both.

3. The method of claim 2, wherein the application of the second computing device is actively listening for one or more verbal triggers while the one or more steps are being audibly executed.

4. The method of claim 3, wherein the one or more verbal triggers include one or more commands; and
wherein the one or more commands include a next command, repeat command, previous command, help command, feedback command, quit command, or any combination thereof.

5. The method of claim 4, wherein the next command causes the application to request a subsequent work step from the processor for audible execution on the audio device.

6. The method of claim 4, wherein the repeat command causes the application to request a current work step from the processor for audible execution on the audio device.

7. The method of claim 4, wherein the prior command causes the application to request a prior work step from the processor for audible execution on the audio device.

8. The method of claim 4, wherein the help command causes the application to request and cause the processor to generate and transmit an electronic notification of assistance needed by the second user to a supervisor of the second user.

9. The method of claim 4, wherein the feedback command causes the application to receive feedback in audible form from the second user via the microphone, transmit the feedback to the processor, and the processor stores the feedback as part of a feedback record.

10. The method of claim 1, wherein as part of the second user logging into the other application, the other application determines a geolocation of the second computing device and transmits the geolocation to the processor; and
wherein as part of the automatically confirming the user credentials, the processor confirms the geolocation is an allowed geolocation for the second user.

11. The method of claim 1, wherein the second computing device is a mobile device and the application is a mobile application stored on the mobile device.

12. The method of claim 11, wherein the mobile application of the mobile device is in communication with the processor via a network.

13. The method of claim 12, wherein the network includes a cellular data network.

14. The method of claim 12, wherein the audio device is separate from and in wireless communication with the mobile device.

15. The method of claim 13, wherein the audio device is in communication with the mobile device via Bluetooth®, Wi-Fi, or other wireless signal.

16. The method of claim 1, wherein a timer is started by the application and/or the processor when the audio device audibly executes the one or more steps of the one or more workflows.

17. The method of claim 16, wherein the timer is stopped by the application and/or the processor when the second user completes performance of the one or more actions associated with the one or more steps; and
wherein completion of the one or more steps is known by the second user provides one or more audible triggers ending the step and either moving on to a subsequent step or ending the workflow.

18. The method of claim 17, wherein a duration of performance of a step of a work flow is determined by the application and/or the processor as the time elapsed between the timer being started and stopped; and
wherein the duration is stored as part of a performance record in a performance database part of the verbal workflow management system.

19. The method of claim 18, wherein the method includes one or more users executing one or more performance queries on a computing device having access to another application of the verbal workflow management system;
wherein the application transmits the performance query to the processor;
wherein the processor accesses the performance database and generates a performance report for a plurality of instances of one or more workflows, steps of workflows, or both; and
wherein the processor transmits the performance report to the application for viewing by the one or more users on the computing device.

20. The method of claim 19, wherein the performance report determines a mean, median, or mode performance level; and
wherein the performance report visually conveys to the one or more users which instances of the steps being performed where above, within, or below the mean, the median, or the mode.
